(19) United States
(12) Patent Application Publication
(10) Pub. No.: US 2014/0304175 A1
(43) Pub. Date: Oct. 9, 2014

(54) LEASING SYSTEM

(71) Applicant: Casper & Friends, Inc., Odessa, FL (US)

(72) Inventor: Gary Casper, Odessa, FL (US)

(73) Assignee: CASPER & FRIENDS, INC., Odessa, FL (US)

(21) Appl. No.: 14/220,835

(22) Filed: Mar. 20, 2014

Related U.S. Application Data
(60) Provisional application No. 61/853,545, filed on Apr. 8, 2013.

(51) Int. Cl. G06Q 30/06

(52) U.S. Cl. CPC G06Q 30/0645
USPC 705/307

(57) ABSTRACT

The present invention provides a system for leasing blocks of time for a commercial object. The system comprising listing one or more available blocks of time for leasing the commercial object into a web based system. The listing of one or more available blocks of time for leasing the commercial object being entered into the web based system by an owner of the commercial object. A prequalification is set for one or more independent contractors to bid on the leasing of the listed available blocks of time for the commercial object. The prequalification being set by the owner of the commercial object. One or more independent contractors are accepted as prequalified based on the set prequalification. The leasing of one or more of the available blocks of time for the commercial object are bided on via the web based system. The bidding being done by one or more of the accepted prequalified independent contractors. The leasing of one or more of the available blocks of time for the commercial object is awarded to a winning prequalified independent contractor via the web based system.

### CROSS REFERENCES TO RELATED APPLICATIONS

This application claims priority from and is related to commonly owned U.S. Provisional Patent Application Ser. No. 61/853,545 filed Apr. 8, 2013, entitled: Internet-Based Leasing and Subleasing, this Provisional Patent Application incorporated by reference herein.

### FIELD OF THE INVENTION

The present invention relates to a system and method for leasing blocks of time for a commercial object. The invention allows owners of a commercial object to lease the commercial object to a prequalified independent contractor and thereby increase the income derived from the commercial object.

### BACKGROUND OF THE INVENTION

The concept of combining businesses into a single leasable space permeates our society. For example, Taco Bell and Kentucky Fried Chicken operate from the same building while sharing employees and operating expenses. Doctors, lawyers and other professionals share space any possibly employees. Airlines lease seats; hotels rent rooms; and rental car companies lease cars, all from online platforms. Other businesses have developed models to lease unused seats, rooms, and cars.

Until now, no one has developed a scheduling, reserving, and pre-payment system to lease blocks of time for the purpose of subleasing these blocks on an online platform.

Therefore, what is needed is a system which allows an owner of a commercial object to lease the commercial object to approved independent contractors using an online platform.

Nothing in the prior art provides the benefits attendant with the present invention.

Therefore, it is an object of the present invention to provide an improvement which overcomes the inadequacies of the prior art systems and which is a significant contribution to the advancement of leasing commercial objects.

Another object of the present invention is to provide a system for leasing blocks of time for a commercial object comprising: listing one or more available blocks of time for leasing the commercial object into a web based system, said listing being entered by an owner of the commercial object; setting a prequalification for one or more independent contractors to bid on the leasing of the listed available blocks of time for the commercial object, said prequalification being set by the owner of the commercial object; accepting one or more independent contractors as prequalified based on the set prequalification; bidding on the leasing of one or more of the available blocks of time for the commercial object via the web based system, said bidding by one or more of the accepted prequalified independent contractors; and awarding the leasing of one or more of the available blocks of time for the commercial object to a winning prequalified independent contractor via the web based system.

Yet another object of the present invention is to provide a system for leasing blocks of seats on an airplane comprising: listing one or more available blocks of seats for leasing on the airplane into a web based system, said listing being entered by an owner of the airplane; setting a prequalification for one or more independent contractors to bid on the leasing of the listed available blocks of seats on the airplane, said prequalification being set by the owner of the airplane; accepting one or more independent contractors as prequalified based on the set prequalification; bidding on the leasing of one or more of the available seats on the airplane via the web based system, said bidding by one or more of the accepted prequalified independent contractors; and awarding the leasing of one or more of the available seats on the airplane to a winning prequalified independent contractor via the web based system.

Still yet another object of the present invention is to provide a system for leasing a medical room at a medical facility comprising: listing one or more available medical rooms for leasing at the medical facility into a web based system, said listing being entered by an owner of the medical facility; setting a prequalification for one or more independent contractors to bid on the leasing of the listed medical rooms at the medical facility, said prequalification being set by the owner of the medical facility; accepting one or more independent contractors as prequalified based on the set prequalification; bidding on the leasing of one or more of the available medical rooms at the medical facility via the web based system, said bidding by one or more of the accepted prequalified independent contractors; and awarding the leasing of one or more of the medical rooms at the medical facility to a winning prequalified independent contractor via the web based system.

Another object of the present invention is to provide a system for leasing blocks of rooms comprising: listing one or more available blocks of rooms for leasing into a web based system; setting a prequalification for one or more independent contractors to bid on the leasing of the listed available blocks of rooms, said prequalification being set by the owner of the available block of rooms; accepting one or more independent contractors as prequalified based on the set prequalification; bidding on the leasing of one or more of the available rooms via the web based system, said bidding by one or more of the accepted prequalified independent contractors; and awarding the leasing of one or more of the available rooms to a winning prequalified independent contractor via the web based system.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

A feature of the present invention is to provide a system for leasing blocks of time for a commercial object. The system comprising listing one or more available blocks of time for leasing the commercial object into a web based system. The commercial object could be a chair at a hair or nail salon. The listing being entered into the web based system by an owner of the commercial object (chair at the hair or nail salon). A prequalification for one or more independent contractors to bid on the leasing of the listed available blocks of time for the commercial object (chair at the hair or nail salon) is set by the owner of the commercial object (chair at the hair or nail salon). One or more independent contractors are accepted as prequalified by the owner of the commercial object (chair at the hair or nail salon) based on the set prequalification. The acceptance of the prequalified independent contractor can occur through friending of the prequalified independent contractor by the owner of the commercial object (chair at the hair or nail salon). Once qualified, the independent contractor will be able to view a listing of inventory and prices for the commercial object (one or more chairs at the hair or nail salon) via a dashboard. The dashboard of the independent contractor can show the availability of the commercial object (chair at the hair or nail salon) by date, time and price. The leasing of one or more of the available blocks of time for the commercial object (chair at the hair or nail salon) are bided on via the web based system by one or more of the accepted prequalified independent contractors. The leasing of one or more of the available blocks of time for the commercial object (chair at the hair or nail salon) being awarded to a winning prequalified independent contractor via the web based system. A keyless entry system can be used to gain access to the commercial object (chair at the hair or nail salon) by the winning prequalified independent contractor. A video monitoring system can be used to monitor the commercial object (chair at the hair or nail salon) by the owner of the commercial object (chair at the hair or nail salon) being used by the winning prequalified independent contractor. In addition, the winning prequalified independent contractor can list the awarded block of time of the commercial object (chair at the hair or nail salon) on their own dashboard as part of the web based system as a second listing of the awarded block of time of the commercial object (chair at the hair or nail salon). The second leasing of the winning block of time for the commercial object (chair at the hair or nail salon) can be bided on via the web based system by one or more of the accepted prequalified independent contractors. The second leasing of the winning block of time for the commercial object (chair at the hair or nail salon) can be awarded to a second winning prequalified independent contractor via the web based system.

Another feature of the present invention is to provide a system for leasing blocks of seats on an airplane. The system comprising listing one or more available blocks of seats for leasing on the airplane into a web based system. The listing of one or more available blocks of seats for leasing on the airplane being entered by an owner of the airplane. A prequalification for one or more independent contractors to bid on the leasing of the listed available blocks of seats on the airplane being set by the owner of the airplane. One or more independent contractors being accepted as prequalified based on the set prequalification. The acceptance of the prequalified independent contractor can occur through friending of the prequalified independent contractor by the owner of the airplane. Once prequalified, the independent contractor will be able to view a listing of the inventory of seats on the airplane and the respective prices via a dashboard. The dashboard of the independent contractor can show the available seats on the airplane by date, time and price. The leasing of one or more of the available seats on the airplane being bided on via the web based system by one or more of the accepted prequalified independent contractors. The leasing of one or more of the available seats on the airplane being awarded to a winning prequalified independent contractor via the web based system. The awarded block of seats on the airplane can be listed by the winning prequalified independent contractor for a second leasing of the seats on the airplane using the web based system. The second leasing of the winning block of seats on the airplane can be bided on via the web based system by one or more of the accepted prequalified independent contractors. The second leasing of the winning block of seats on the airplane can be awarded to a second winning prequalified independent contractor via the web based system.

Yet another feature of the present invention is to provide a system for leasing a medical room at a medical facility. The system comprising listing one or more available medical rooms for leasing at the medical facility into a web based system. The listing of the one or more available medical rooms for leasing at the medical facility being entered by an owner of the medical facility. A prequalification for one or more independent contractors to bid on the leasing of the listed medical rooms at the medical facility being set by the owner of the medical facility. One or more independent contractors being accepted as prequalified based on the set prequalification. The acceptance of the prequalified independent contractor can occur through friending of the prequalified independent contractor by the owner of the medical facility. Once prequalified, the independent contractor will be able to view a listing of inventory and prices for the medical rooms at the medical facility via a dashboard. The dashboard of the independent contractor can show the medical rooms at the medical facility by date, time and price. The leasing of one or more of the available medical rooms at the medical facility being bided on via the web based system by one or more of the accepted prequalified independent contractors. The leasing of one or more of the medical rooms at the medical facility being awarded to a winning prequalified independent contractor via the web based system. The awarded medical room can be listed by the winning prequalified independent contractor for a second leasing at the medical facility using the web based system. A second leasing of the winning medical room at the medical facility can be bided on via the web based system by one or more of the accepted prequalified independent contractors. The second leasing of the winning medical room at the medical facility can be awarded to a second winning prequalified independent contractor via the web based system.

Still yet another feature of the present invention is to provide a system for leasing blocks of rooms. The system comprising listing one or more available blocks of rooms for leasing into a web based system. The available rooms can be on a cruise ship or in a hotel. A prequalification for one or more independent contractors to bid on the leasing of the listed available blocks of rooms (on the cruise ship or in the hotel) being set by the owner of the rooms. One or more independent contractors being accepted as prequalified based on the set prequalification. The acceptance of the prequalified independent contractor can occur through friending of the prequalified independent contractor by the owner of the available blocks of rooms (on the cruise ship or in the hotel). Once prequalified, the independent contractor will be able to view a listing of inventory and prices for the available blocks of rooms (on the cruise ship or in the hotel) via a dashboard. The dashboard of the independent contractor can show the available blocks of rooms (on the cruise ship or in the hotel) by date, time and price. The leasing of one or more of the available rooms (on the cruise ship or in the hotel) being bided on via the web based system by one or more of the accepted prequalified independent contractors. The leasing of one or more of the available rooms (on the cruise ship or in the hotel) being awarded to a winning prequalified independent contractor via the web based system.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a block diagram depicting a system for leasing blocks of time for a commercial object according to an embodiment of the invention;

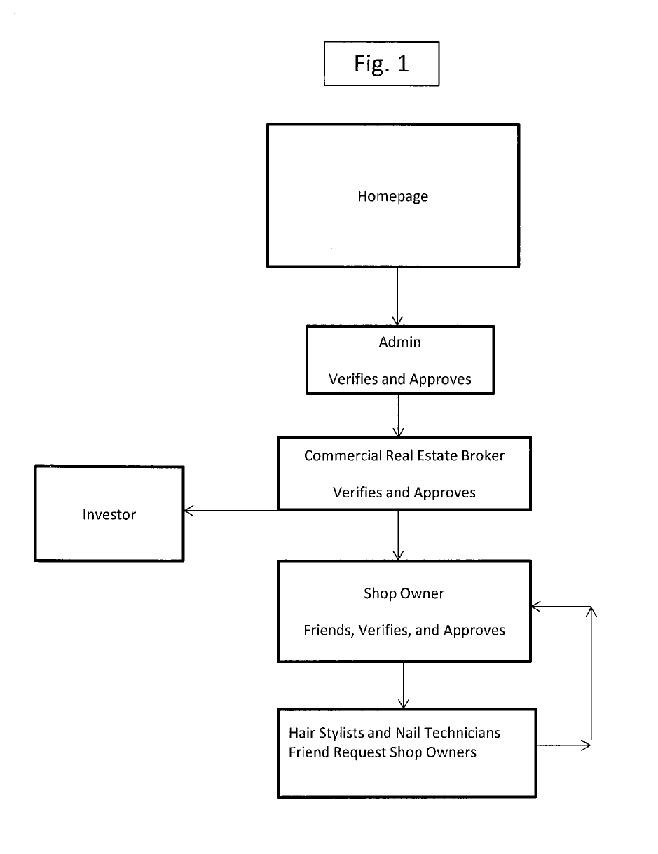

FIG. 2 is a block diagram depicting a system for leasing a chair at a nail or hair salon according to an embodiment of the invention;

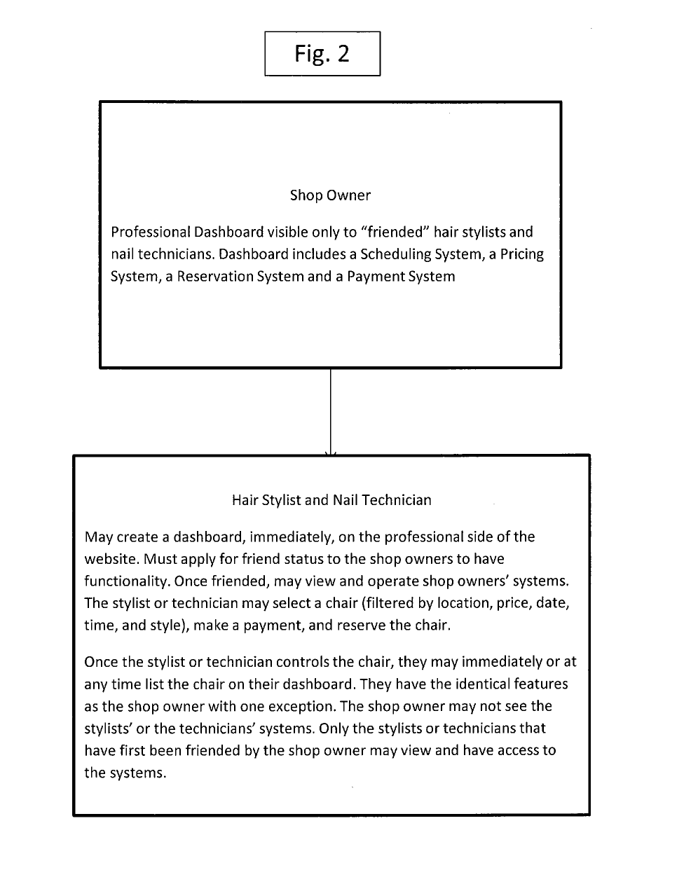

FIG. 3 is a block diagram depicting a system for leasing a block of seats on an airplane according to an embodiment of the invention; and

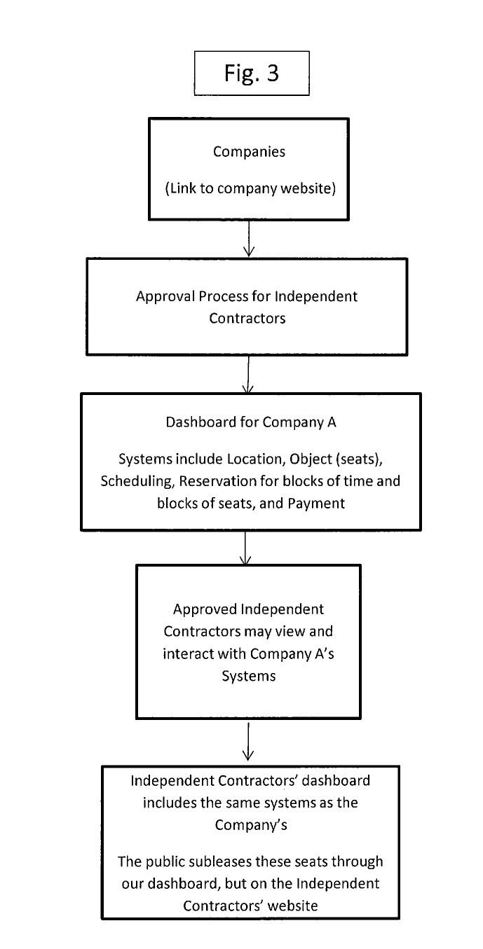

FIG. 4 is a block diagram depicting a system for leasing rooms on a cruise ship or in a hotel according to an embodiment of the invention.

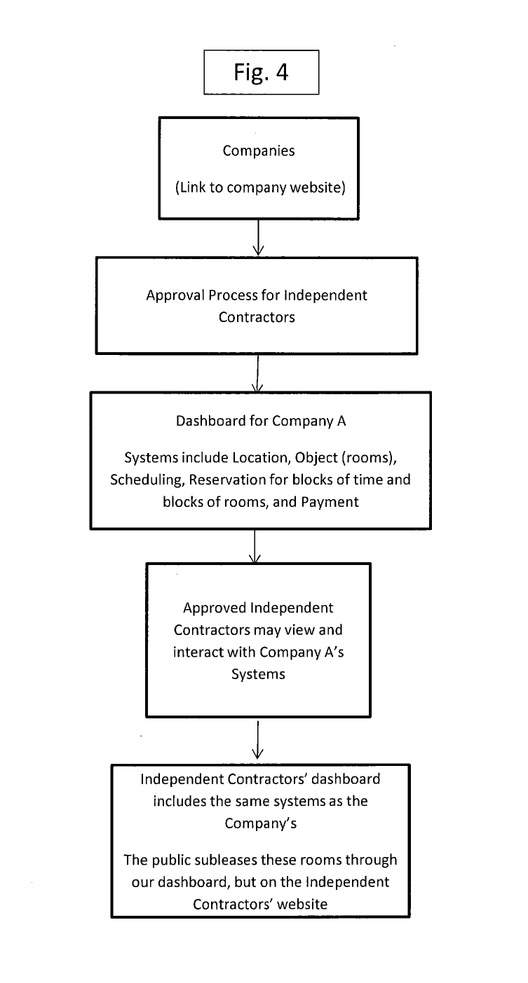

Similar reference characters refer to similar parts throughout the several views of the drawings.

### DETAILED DESCRIPTION OF THE INVENTION

Using the system of the present invention, an owner of a business, such as a hair or nail salon, can now allow approved independent contractors or employees to sublease the business owner's chairs. The system of the present invention can also allow the approved independent contractors or employees to buy blocks of time for the use of a salon chair from the owner of the salon and sublease the blocks of time to other approved independent contractors or employees.

This internet based system breaks down the leasable time periods into segments as small as necessary for the particular business that is offering a commercial object such as a seat on an airline for lease. In this example, a third party might wish to lease a block of airline seats on a particular plane for a particular destination. The time period for the lease of the seats will be undetermined, but the seat on the airline will be the constant.

Using the system of the present invention, the owner of the commercial object for lease maintains complete control of the selection process with the approval of the independent contractor that can lease the commercial object. For example, the owner of the commercial object for lease will verify the information of the independent contractor. In many cases, a personal interview might take place. At the owner's discretion, they will approve (e.g., “friend”) of the independent contractor.

Once approved (e.g., “friended”) by the owner of the commercial object for lease, the independent contractor will have the ability to view the owner's commercial object(s) for lease and the associated prices for the commercial object(s) via a dashboard. The independent contractor reserves the commercial object for lease by date, time, and price. The independent contractor completes the reservation process by paying, e.g., through PayPal, the cost of the leasing of the commercial object.

Once the independent contractor completes the reservation process, the commercial object for lease becomes the inventory of the independent contractor. Now, the independent contractor may use the commercial object during the reserved lease period, or sublease the commercial object to another independent contractor. However, only independent contractors who have previously been approved (e.g., “friended”) by the owner of the commercial object will have the ability to view and sublease the commercial object as listed by the independent contractor. Thus, the owner of the commercial object for lease maintains complete control of the process, as the owner of the commercial object for lease may remove the approval (e.g., “unfriend”) an independent contractor at any time and for any reason.

This internet based system will enable the owner of a commercial object to lease the commercial object 24 hours a day, 7 days a week. In addition, the owner of the commercial object can lease the commercial object without direct management supervision. For example, the owner of the commercial object can use a keyless entry system, and/or a video monitoring device for the supervision of the commercial object during the time that the independent contractor is using the commercial object.

In one embodiment of the present invention, shop owners (salon, barber, and nail) will make the chairs of their shop available for rent to the hair stylists and the nail technicians on the internet. The present invention allows the shop owners to administrate their business at their own discretion. This means that the shop owners will determine their own schedule, and the price of each chair, on a weekly, daily, hourly, or even a half hourly basis. The shop owners will also have the flexibility to change any price immediately. The stylists and the technicians will make all of their reservations online through a calendar system that is provided by each shop owner. All reservations will be booked and paid in advance through a payment system on the internet (e.g., PayPal).

In using the present invention, each shop owner (salon, barber, and nail) receives a unique identifier to login to their own dashboard. Contained in the shop owner's dashboard, is a modifiable schedule system for leasing the chair in the shop. The shop owner enters the chair, the price of the chair, and the hours the chair is available into the shop owner's dashboard. The hours are set for each half-hour with a day discount and a week discount. The schedule remains constant on a weekly basis as long as the shop owner wishes to not make any modifications. However, at any time, the shop owner can make a modification to any variable in the chair's schedule.

The shop owner will first verify and approve of every hair stylist and/or nail technician who wants to work in their shop. The process will be initiated by the hair stylist and/or the nail technician using their own dashboard to apply and be approved by the shop owner. Once approved, the stylists and/or nail technicians may reserve an unlimited number of chairs and hours from an unlimited number of their approved shop owners. These stylists and/or technicians may then sublease the chairs to other approved stylists and/or technicians.

All pre-qualifications that the shop owner requires for approval of a hair stylist and/or nail technician are unique and subject to the individual specifications of the shop owner. The shop owner may require the hair stylist and/or nail technician to come into the shop for a personal interview or they may even require the hair stylist and/or nail technician to perform some services for an inspection of their quality.

Using their dashboard, the hair stylists and/or the nail technicians may view the shop owner's profile page, as completed on the professional side. For every shop that meets the hair stylists and/or nail technician's criteria, they may send an approval (e.g., “friend”) request to that shop through their dashboard. The shop owner receives a request for approval via their dashboard or an email from the hair stylist and/or nail technician that made the request for approval. The shop owner approves (e.g., friends) the hair stylist and/or nail technician based upon their individual qualification criteria.

The shop owner's dashboard can have a tab that lists all of the “friend” requests from the hair stylists and/or nail technicians. The shop owner only has to click on the “APPROVE” icon on the shop owner's dashboard to approve the hair stylist or nail technician. In reverse, the shop owner may at any time click the “DENY” tab on the shop owner's dashboard to prevent the hair stylist and/or nail technician from viewing or interacting with the leasing system for their shop.

Each shop owner sets their pricing strategy for the chair that is being leased. The leasing system of the present invention may have a fixed price (modifiable) for each chair. In one embodiment, the hair stylist and/or nail technician only has to choose the salon, chair, and time and click “BUY” on the hair stylist and/or nail technician's dashboard to reserve and pay for the chair at the respective shop. In an alternative embodiment, the approved hair stylist and/or nail technician bids on the available chair at the hair or nail salon.

In the airline embodiment of the present invention, each airline company receives a unique identifier to login to their own dashboard. Contained in each airline dashboard, is a modifiable schedule system for the flights that each airline would like to sell seats. Each airline enters the flight number, the type of seat (first class, etc.), the price of the seat, and the price for multiple seats into their dashboard. Each airline company enters the pricing structure for every flight and every time. At any time, the airline company, through its dashboard, can make a modification to any variable in the available seat's schedule and/or pricing.

The pre-qualifications that each airline company requires are unique and subject to the individual specifications of each airline. Each airline will confidentially send a request (e.g., “friend”) invitation to each wholesaler. Once the wholesaler accepts the invitation through the wholesaler's dashboard, the wholesaler will have viewing and interacting access to the airline's seats that have been listed by the airline in the airline's dashboard.

The airline's dashboard will show the invitations sent and the invitations that have been accepted. Each airline will still have the ability to exclude a wholesaler at any time in the future. Each airline company sets their pricing strategy.

The leasing system has a fixed price (modifiable) for each passenger seat on the airline. In one embodiment, the wholesaler only has to choose the date, flight, seat(s), click “BUY” on the wholesaler's dashboard to reserve and pay for the seat(s) on the airline. In an alternative embodiment, the approved wholesalers bid on the available seat(s) on the airline.

In the hotel embodiment of the present invention, each hotel company receives a unique identifier to login to their own dashboard. Contained in each hotel dashboard, is a modifiable schedule system for the hotel rooms that each hotel would like to rent. The hotel enters each individual room, the type of room (balcony, ocean view, king size bed, smoking, etc.), the price of the room, and the price for multiple rooms (assorted styles, etc.). The weekly pricing structure for each room is set as a constant. After the hotel sets the initial weekly pricing structure, the price for each room on each day may be modified at any time by the hotel using the hotel's dashboard.

All pre-qualifications each hotel requires are unique and subject to the individual specifications of each hotel. Each hotel will confidentially send a request (e.g., “friend”) invitation to each wholesaler. Once the wholesaler accepts the invitation, the wholesaler will have viewing and interacting access to the hotel's schedule via the wholesaler's dashboard.

The hotel's dashboard will show the invitations sent and the invitations that have been accepted. Each hotel will continue to have the ability to exclude a wholesaler at any time in the future.

Each hotel sets their own pricing strategy for the rooms that are for rent. The leasing system has a fixed price (modifiable) for each hotel room. In one embodiment, the wholesaler only has to choose the date, room, or number of rooms, click “BUY” on the wholesaler's dashboard to reserve and pay for the room(s). In an alternative embodiment, the approved wholesalers bid on the available room(s) for rent in the hotel.

In the cruise embodiment of the present invention, each cruise line company receives a unique identifier to login to their own dashboard. Contained in each cruise line's dashboard, is a modifiable schedule system for the cruises that each cruise line would like to sell rooms. The cruise line enters each individual room, the type of room (balcony, ocean view, size of room, etc.), the price of the room, and the price for multiple rooms (assorted styles, etc.). The trip pricing structure for each room on each ship is set as a constant. After the cruise line sets the initial weekly pricing structure, the price for each room on each day may be modified at any time by the respective cruise line using the cruise line's dashboard.

All pre-qualifications the cruise lines require are unique and subject to the individual specifications of each cruise line. Each cruise line will confidentially send a request (e.g., “friend”) invitation to each wholesaler. Once the wholesaler accepts the invitation, they will have viewing and interacting access to the cruise line's schedule via the wholesaler's dashboard.

The cruise line's dashboard will show the invitations sent and the invitations that have been accepted. Each cruise line will continue to have the ability to exclude a wholesaler at any time in the future using the cruise line's dashboard.

Each cruise line sets their pricing strategy. The leasing system has a fixed price (modifiable) for each ship's room using the cruise line's dashboard. In one embodiment, the wholesaler only has to choose the date, room, or number of rooms, click “BUY” on the wholesaler's dashboard to reserve and pay for the room(s). In an alternative embodiment, the approved wholesalers bid on the available room(s) on the cruise ship.

In the doctor office embodiment of the present invention, each doctor's office receives a unique identifier to login to their own dashboard. Contained in each doctor's office dashboard, is a modifiable schedule system for the rooms that each doctor's office would like to lease. The doctor's office enters each individual room, the type of room (x-ray room, dentist chair, surgery chair, orthodontic chair, general office no restrictions, etc.), and the price of the room. The weekly pricing structure for each room is set as a constant. After the doctor's office sets the initial weekly pricing structure, the price for each room on each day may be modified at any time using the doctor's office dashboard.

All pre-qualifications the doctor's office requires are unique and subject to the individual specifications of each doctor's office. The doctors, dentists, or licensed medical providers may view the doctor's office profile page, as completed on the professional side using their own dashboard. For every doctor's office that meets the doctors, dentists, or licensed medical providers criteria, they may send a request (e.g., “friend”) to the respective doctor's office. The doctor's office receives an email or notification on the doctor's office dashboard of the request. The doctor's office can then choose to approve of the request from the doctor, dentist, or licensed medical provider based upon their individual qualification criteria.

On the doctor's office dashboard there is a tab that lists all of the “friend” requests. The doctor's office only has to click on the “APPROVE” icon to approve the doctors, dentists, or licensed medical providers. In reverse, the doctor's office may at any time click the “DENY” tab on the doctor's office dashboard to prevent the doctors, dentists, or licensed medical providers from viewing or interacting with the leasing system.

Each doctor's office sets their pricing strategy. The leasing system has a fixed price (modifiable) for each room.

In one embodiment, the doctors, dentists, or licensed medical providers only has to choose the doctor's office, date, room, and time and click “BUY” on their respective dashboard to reserve and pay for the room. In an alternative embodiment, the approved doctors, dentists, or licensed medical providers bid on the room(s) at the doctor's office.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A system for leasing blocks of time for a commercial object comprising:
listing one or more available blocks of time for leasing the commercial object into a web based system, said listing being entered by an owner of the commercial object;
setting a prequalification for one or more independent contractors to bid on the leasing of the listed available blocks of time for the commercial object, said prequalification being set by the owner of the commercial object;
accepting one or more independent contractors as prequalified based on the set prequalification;
bidding on the leasing of one or more of the available blocks of time for the commercial object via the web based system, said bidding by one or more of the accepted prequalified independent contractors; and
awarding the leasing of one or more of the available blocks of time for the commercial object to a winning prequalified independent contractor via the web based system.

2. The system according to claim 1 wherein said commercial object is a chair at a salon.

3. The system according to claim 2 further comprising:
listing the awarded block of time of the chair for a second leasing at the salon into a web based system, said listing being entered by the winning prequalified independent contractor;
bidding on the second leasing of the winning block of time for the chair at the salon via the web based system, said bidding by one or more of the accepted prequalified independent contractors; and
awarding the second leasing of the winning block of time for the chair at the salon to a second winning prequalified independent contractor via the web based system.

4. The system according to claim 2 wherein said acceptance of the prequalified independent contractor further comprising friending of the prequalified independent contractor by the owner of the salon.

5. The system according to claim 4 further comprising a listing of inventory and prices for one or more chairs at the salon.

6. The system according to claim 5 further comprising reserving the chair at the salon by date, time and price.

7. The system according to claim 2 further comprising a keyless entry system at the salon to allow access to the salon by the winning prequalified independent contractor.

8. The system according to claim 2 further comprising a video monitoring system at the salon to allow the owner of the salon to monitor use of the salon by the winning prequalified independent contractor.

9. A system for leasing blocks of seats on an airplane comprising:
listing one or more available blocks of seats for leasing on the airplane into a web based system, said listing being entered by an owner of the airplane;
setting a prequalification for one or more independent contractors to bid on the leasing of the listed available blocks of seats on the airplane, said prequalification being set by the owner of the airplane;
accepting one or more independent contractors as prequalified based on the set prequalification;
bidding on the leasing of one or more of the available seats on the airplane via the web based system, said bidding by one or more of the accepted prequalified independent contractors; and
awarding the leasing of one or more of the available seats on the airplane to a winning prequalified independent contractor via the web based system.

10. The system according to claim 9 further comprising:
listing the awarded block of seats for a second leasing on the airplane into a web based system, said listing being entered by the winning prequalified independent contractor;
bidding on the second leasing of the winning block of seats on the airplane via the web based system, said bidding by one or more of the accepted prequalified independent contractors; and
awarding the second leasing of the winning block of seats on the airplane to a second winning prequalified independent contractor via the web based system.

11. The system according to claim 9 wherein said acceptance of the prequalified independent contractor further comprising friending of the prequalified independent contractor by the owner of the airplane.

12. The system according to claim 11 further comprising a listing of inventory and prices for the seats on the airplane.

13. The system according to claim 12 further comprising reserving the seats on the airplane by date, time and price.

14. A system for leasing a medical room at a medical facility comprising:
listing one or more available medical rooms for leasing at the medical facility into a web based system, said listing being entered by an owner of the medical facility;
setting a prequalification for one or more independent contractors to bid on the leasing of the listed medical rooms at the medical facility, said prequalification being set by the owner of the medical facility;
accepting one or more independent contractors as prequalified based on the set prequalification;
bidding on the leasing of one or more of the available medical rooms at the medical facility via the web based system, said bidding by one or more of the accepted prequalified independent contractors; and
awarding the leasing of one or more of the medical rooms at the medical facility to a winning prequalified independent contractor via the web based system.

15. The system according to claim 14 further comprising:
listing the awarded medical room for a second leasing at the medical facility into a web based system, said listing being entered by the winning prequalified independent contractor;
bidding on a second leasing of the winning medical room at the medical facility via the web based system, said bidding by one or more of the accepted prequalified independent contractors; and
awarding the second leasing of the winning medical room at the medical facility to a second winning prequalified independent contractor via the web based system.

16. The system according to claim 14 wherein said acceptance of the prequalified independent contractor further comprising friending of the prequalified independent contractor by the owner of the medical facility.

17. The system according to claim 16 further comprising a listing of inventory and prices for the medical rooms at the medical facility.

18. The system according to claim 17 further comprising reserving the medical rooms at the medical facility by date, time and price.

19. A system for leasing blocks of rooms comprising:
listing one or more available blocks of rooms for leasing into a web based system;
setting a prequalification for one or more independent contractors to bid on the leasing of the listed available blocks of rooms, said prequalification being set by the owner of the available block of rooms;
accepting one or more independent contractors as prequalified based on the set prequalification;
bidding on the leasing of one or more of the available rooms via the web based system, said bidding by one or more of the accepted prequalified independent contractors; and
awarding the leasing of one or more of the available rooms to a winning prequalified independent contractor via the web based system.

20. The system according to claim 19 wherein the available rooms are on a cruise ship.

21. The system according to claim 19 wherein the available rooms are in a hotel.
